(19) United States
(12) Patent Application Publication
(10) Pub. No.: US 2007/0098584 A1
(43) Pub. Date: May 3, 2007

(54) Compact fluid pump having a simplified structure

(75) Inventors: Alex Horng, Kaohsiung (TW); Tso-Kuo Yin, Kaohsiung Hsien (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/329,044

(22) Filed: Jan. 11, 2006

(30) Foreign Application Priority Data
Nov. 1, 2005 (TW) 94138209

(51) Int. Cl. F04C 29/00; F04C 2/00; F01C 1/18; F16N 13/20; F01C 21/00; F04C 18/00

(52) U.S. Cl. 418/2; 418/206.1

(57) ABSTRACT

A fluid pump includes a housing having a sealed interior space, at least one drive gear mounted in the interior space of the housing for driving a fluid, a magnetically inductive member coupled to the drive gear, and a stator device mounted outside the housing and located corresponding to the magnetically inductive member so that the overall thickness of the fluid pump is reduced. The stator device creates alternating energizing when supplied with electricity, thereby driving the magnetically inductive member and the drive gear to deliver the fluid.

### BACKGROUND OF THE INVENTION

1. Field of the Invention

The present invention relates to a fluid pump, and more particularly to a fluid pump having a simplified structure for avoiding fluid leakage.

2. Description of Related Art

FIG. 1 of the drawings illustrates a conventional fluid pump comprising a housing 10, a drive gear 20, a driven gear 30, and a driving member 40. The housing 10 receives the drive gear 20 and the driven gear 30 that mesh with each other. A lid 11 covers the housing 10. An inlet pipe 101 is connected to a first side of the housing 10 in a location adjacent to a joining area between the drive gear 20 and the driven gear 30. An outlet pipe 102 is connected to a second side of the housing 10 in a location opposite to the inlet pipe 101. The driving member 40 includes a shaft 41 extending through the housing 10 and a center of the drive gear 20. The driven gear 30 is extended through by a shaft 31 that is mounted to a seat (not shown) in the lid 11.

In operation, the inlet pipe 101 and the outlet pipe 102 are coupled to a fluid-cooling type heat-dissipating module (not shown). Fluid is input via the inlet pipe 101. The driving member 40 drives the drive gear 20 to turn (e.g., counterclockwise) through the shaft 41, which, in turn, drives the driven gear 30 to turn (e.g., clockwise) simultaneously. The teeth of the drive gear 20 and the driven gear 30 cause the fluid to flow along an inner perimeter of the housing 10 and then be output via the outlet pipe 102. Thus, the fluid can be fed to an object (such as a central processing chip of a computer) to be dissipated for heat-dissipating purposes.

However, the housing 10 must include a hole (not shown) to allow the shaft 41 of the driving member 40 to extend therethrough for engaging with the drive gear 20, which hole results in a risk of leakage of the fluid via a gap between a circumference of the shaft 41 and a circumferential wall delimiting the hole of the housing 10. Even though gaskets are mounted on both sides of the hole of the housing 10, the leakage problem could not be completely solved. Further, the fluid pump, when used for dissipating heat inside a computer, operates in a high-temperature environment such that the hole of the housing 10, the shaft 41, and the gaskets expand and shrink in response to a change in the temperature. The housing 10, the shaft 41, and the gaskets are thus apt to oxidize, deform, and deteriorate. As a result, the size of the gap between the shaft 41 and the circumferential wall delimiting the hole of the housing 10 increases, aggregating the leakage problem and leading to rusting, short circuit, and damage to the fluid pump, the heat-dissipating model, and the object. Further, the driving member 40 occupies a considerable space and thus limits application of the fluid pump.

### OBJECTS OF THE INVENTION

An object of the present invention is to provide a compact fluid pump with reduced thickness for miniaturization purposes.

Another object of the present invention is to provide a compact fluid pump for avoiding fluid leakage.

A further object of the present invention is to provide a compact fluid pump with improved operational reliability.

Still another object of the present invention is to provide a compact fluid pump having a prolonged life.

### SUMMARY OF THE INVENTION

A fluid pump in accordance with the present invention comprises a housing including a sealed interior space, at least one drive gear mounted in the interior space of the housing for driving a fluid, a magnetically inductive member coupled to the drive gear, and a stator device mounted outside the housing and located corresponding to the magnetically inductive member so that the overall thickness of the fluid pump is reduced. The stator device creates alternating energizing when supplied with electricity, thereby driving the magnetically inductive member and the drive gear to deliver the fluid.

The compact fluid pump may further comprise an inlet pipe and an outlet pipe connected to the housing and in communication with the interior space of the housing. The inlet pipe allows input of the fluid into the interior space of the housing and the outlet pipe allows output of the fluid out of the housing.

Preferably, the magnetically inductive member is made of magnetic material and comprises a plurality of pole sections.

In an embodiment of the invention, the stator device comprises at least two coils.

The stator device may further comprise at least two iron cores respectively mounted inside an associated one of the coils to increase alternating energizing intensity.

The stator device may further comprise at least one sensor mounted between two coils for detecting a change in polarity during rotation of the magnetically inductive member.

Preferably, the stator device is concentric with the drive gear and the magnetically inductive member.

Preferably, the housing comprises a lid mounted thereto for defining the sealed interior space.

Preferably, each of the housing and the lid comprises a shaft seat. The drive gear comprises a shaft that is rotatably coupled to the shaft seat of the housing and the shaft seat of the lid.

Preferably, the lid further comprises a recessed portion for receiving the stator device.

Preferably, the stator device further comprises a circuit board and the lid further comprises a recessed portion for receiving the circuit board.

Preferably, the drive gear comprises a recessed portion surrounding the shaft of the drive gear for securely receiving the magnetically inductive member.

Preferably, the magnetically conductive member further comprises an insulating layer to avoid rusting.

Preferably, the compact fluid pump further comprises at least one driven gear rotatably mounted in the interior space of the housing and meshed with the drive gear.

Other objects, advantages and novel features of this invention will become more apparent from the following detailed description when taken in conjunction with the accompanying drawings.

### BRIEF DESCRIPTION OF THE DRAWINGS

FIG. 1 is a perspective view, partly exploded, of a conventional fluid pump;

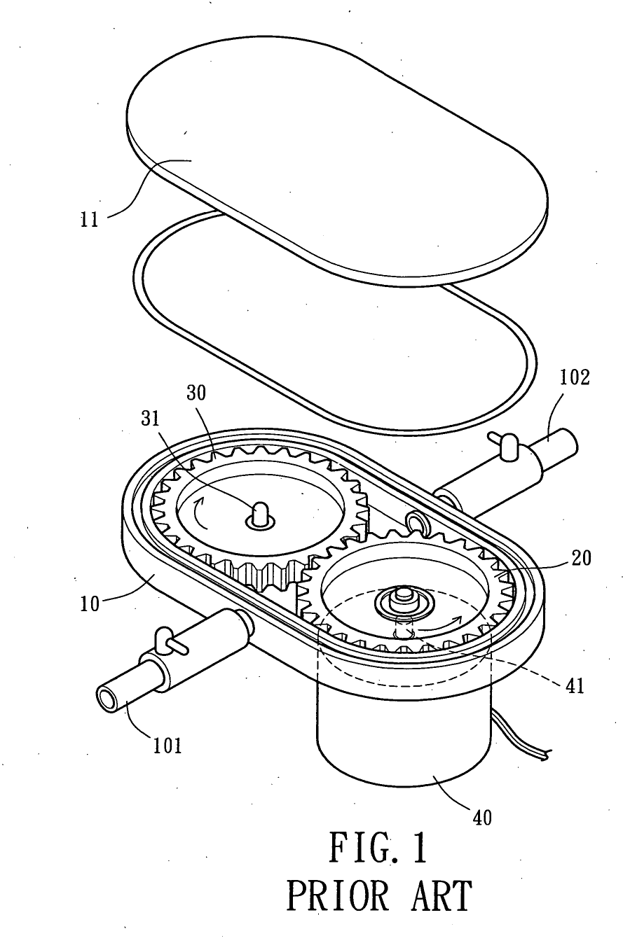

FIG. 2 is a perspective view, partly exploded, of a first embodiment of a compact fluid pump in accordance with the present invention;

FIG. 3 is a sectional view of the compact fluid pump in FIG. 2;

FIG. 4 is a perspective view, partly exploded, of a second embodiment of the compact fluid pump in accordance with the present invention;

FIG. 5 is a sectional view of the compact fluid pump in FIG. 4;

FIG. 6 is a perspective view, partly exploded, of a third embodiment of the compact fluid pump in accordance with the present invention; and

FIG. 7 is a sectional view of the compact fluid pump in FIG. 6.

### DETAILED DESCRIPTION OF THE PREFERRED EMBODIMENTS

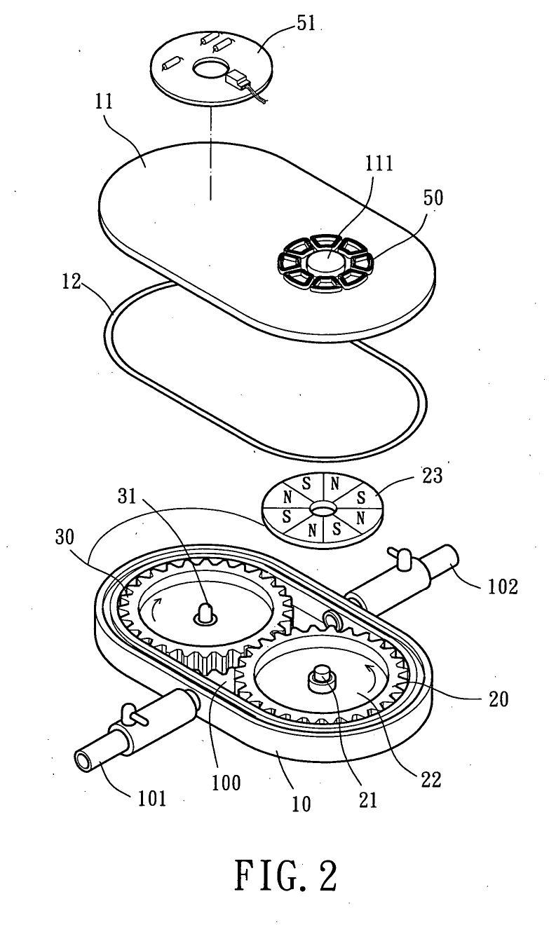

Referring to FIG. 2, a first embodiment of a compact fluid pump in accordance with the present invention comprises a housing 10, at least one drive gear 20, at least one driven gear 30, and a stator device 50. The compact fluid pump may drive a fluid to flow. For example, the compact fluid pump can be coupled with a fluid-cooling type heat-dissipating module (not shown) and drive a fluid to flow in a circulating way for dissipating an object (such as a central processing chip of a computer). The compact fluid pump can be used in other fluid mechanisms and operated in a similar way.

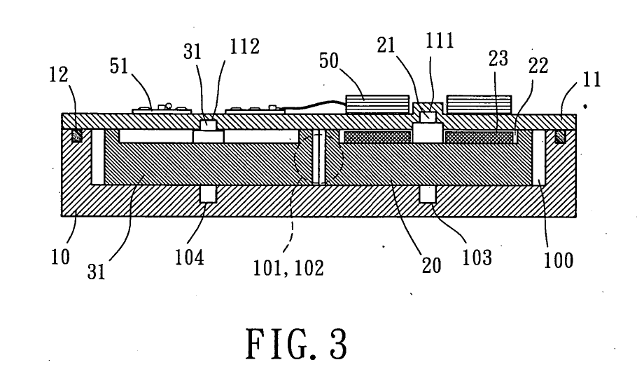

Referring to FIGS. 2 and 3, housing 10 is of an appropriate shape such as elliptic. The housing 10 includes an interior space 100, a first shaft seat 103, and a second shaft seat 104. A lid 11 and a washer (or gasket) 12 are mounted to cover and seal the housing 10. The drive gear 20 and the driven gear 30 are mounted in the interior space 100. An inlet pipe 101 and an outlet pipe 102 are mounted to opposite sides of the housing 10 at locations adjacent to a joint area between the drive gear 20 and the driven gear 30. Fluid enters the housing 10 via the inlet pipe 101 and exits the housing 10 via the outlet pipe 102.

The lid 11 is preferably made of magnetically insulating material or non-metallic material. The lid 11 comprises a first shaft seat 111 and a second shaft seat 112. The first shaft seat 103 of the housing 10 and the first shaft seat 111 of the lid 11 are in association with the drive gear 20 whereas the second shaft seat 104 of the housing 10 and the second shaft seat 112 of the lid 11 are in association with the driven gear 30.

Still referring to FIGS. 2 and 3, the drive gear 20 and the driven gear 30 mesh with each other and are rotatably received in the interior space 100 of the housing 10. Each of the drive gear 20 and the driven gear 30 includes a plurality of teeth (not labeled) on a circumference thereof.

The drive gear 20 comprises a shaft 21 that is rotatably coupled to the first shaft seat 103,111 of the housing 10 and the lid 11, a recessed portion 22 in a side thereof and surrounding the shaft 21, and a magnetically inductive member 23 fixed in the recessed portion 22 by suitable means, e.g., gluing, welding, snapping, or screwing.

The magnetically inductive member 23 is made of magnetic material. The magnetically inductive member 23 may be an integrally formed circular plate. Alternatively, the magnetically inductive member 23 includes a plurality of rectangular or sectorial plates that are assembled together in a symmetric manner. In a case that the magnetically inductive member 23 is a magnet, the magnetically inductive member 23 includes a plurality of north pole sections N and a plurality of south pole sections S, such as eight (8) north pole sections N and eight (8) south pole sections S. Preferably, the magnetically inductive member 23 is covered by an insulating layer (not shown) to prevent from rusting resulting from long-term immersion in the fluid. The insulating layer is provided by application or injection molding to cover the magnetically inductive member 23. The driven gear 30 includes a shaft 31 that is rotatably coupled to the second shaft seat 104 of the housing 10 and the second shaft seat 112 of the lid 11.

Still referring to FIGS. 2 and 3, the stator device 50 of this embodiment, preferably includes at least two coils (eight in this example) that are fixed to the lid 11 by gluing, welding, snapping, or screwing, with the coils annularly fixed on an outer side of the lid 11 along a circumference of the first shaft seat 111 of the lid 11 (or along a circumference of the first shaft seat 103 of the housing 10), and with the stator device 50 and the drive gear 20 being concentrically disposed. The stator device 50 can be supplied with electricity to create alternating energizing. The stator device 50 may further comprise a circuit board 51 that is fixed to the lid 11 by gluing, welding, snapping, or screwing.

Still referring to FIGS. 2 and 3, in operation, electricity is supplied to the stator device 50 to create alternating energizing. Since the stator device 50 is concentric with the magnetically inductive member 23 of the drive gear 20, the magnetically inductive member 23 is induced by alternating magnetic fields created by the stator device 50, resulting in rotational movement of the drive gear 20 along a direction (e.g., counterclockwise, see the arrow in FIG. 2). Meanwhile, the drive gear 20 drives the driven gear 30 to turn clockwise (see the arrow in FIG. 2). Fluid from the inlet pipe 101 is carried by the teeth on the drive gear 20 and the driven gear 30 to flow along an inner perimeter of the housing 10 and then output via the outlet pipe 102.

By using the stator device 50 outside the housing 10 to drive the drive gear 20 by indirect alternating energizing, the stator device 50 does not have to include any shaft that extends through the shaft seat 111 of the lid 11. Leakage of fluid is avoided. Thus, the sealing reliability between the housing 10 and the lid 11 is improved. The sealing effect and operational reliability of the fluid pump are improved and the life of the fluid pump is prolonged.

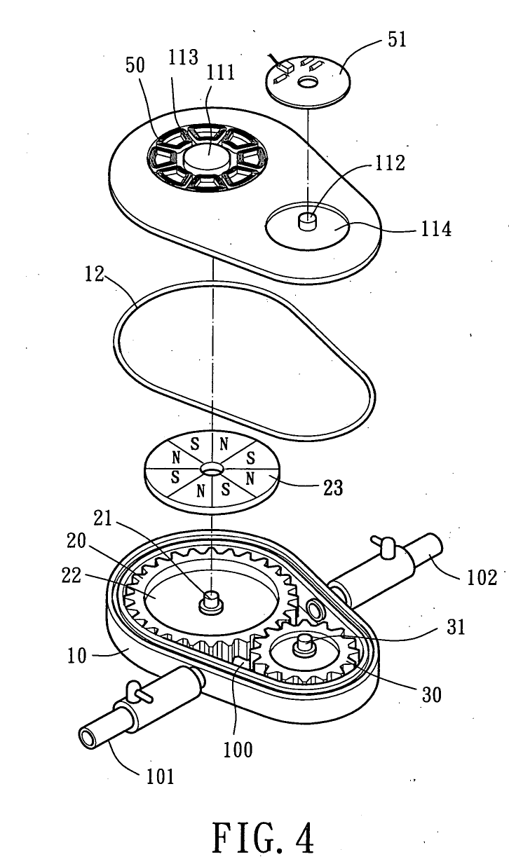

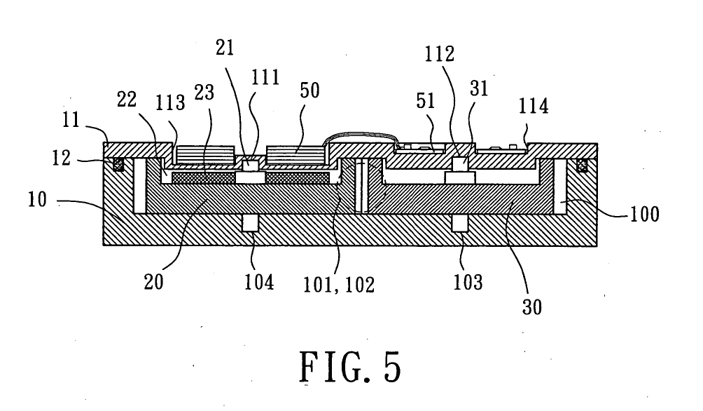

FIGS. 4 and 5 illustrate a second embodiment of the compact fluid pump in accordance with the present invention, wherein the lid 11 further comprises a first groove 113 surrounding the first shaft seat 111 of the lid 11 and a second groove 114 surrounding the second shaft seat 112 of the lid 11. The stator device 50 is received in the first groove 113 and the circuit board-51 is received in the second groove 114.

Further, the drive gear 20 and the driven gear 30 may differ in size. For example, the size of the drive gear 20 may be smaller than that of the driven gear 30 and the number of the teeth of the drive gear 20 may be less than that of the driven gear 30, and vice versa. The number of the drive gear 20 and the driven gear 30 may vary according to need.

Electricity is supplied to the coils of the stator device 50 to create alternating magnetic fields. The magnetically inductive member 23 is indirectly driven to thereby drive the drive gear 20 and the driven gear 30 to turn for delivering the fluid. Similarly, the sealing effect and operational reliability of the fluid pump are improved and the life of the fluid pump is prolonged. Further, the overall thickness of the fluid pump is reduced for miniaturization purposes.

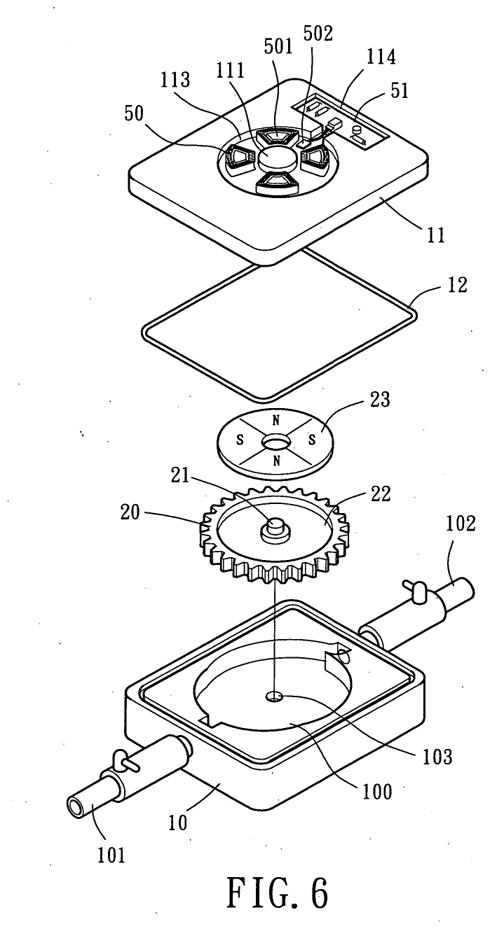

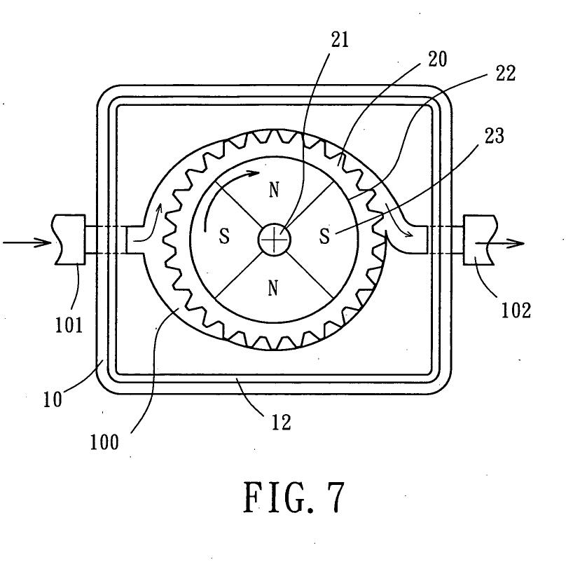

FIGS. 6 and 7 illustrate a third embodiment of the compact fluid pump in accordance with the present invention, wherein the lid 11 comprises a first groove 113 for receiving the stator device 50 and a second groove 114 for receiving the circuit board 51. Further, the stator device 50 further includes at least two iron cores (four in this example) 501 and at least one sensor 502. Each iron core 501 is mounted inside an associated coil of the stator device 50 to increase the alternating energizing intensity. The sensor 502 is mounted between two adjacent coils of the stator device 50 and electrically connected to the circuit board 51 for detecting a change in polarity during rotation of the magnetically inductive member 23, thereby controlling alternating energizing of the stator device 50. The interior space 100 of the housing 10 is designed to receive only the drive gear 20, as the driven gear 30 is omitted. The structure of the fluid pump is thus simplified. Rotation of the drive gear 20 is sufficient to deliver the fluid from the inlet pipe 101 side to the outlet pipe 102 side.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A compact fluid pump comprising:
a housing comprising a sealed interior space;
at least one drive gear mounted in the interior space of the housing for driving a fluid;
a magnetically inductive member coupled to the drive gear; and
a stator device mounted outside the housing and located corresponding to the magnetically inductive member;
the stator device creating alternating energizing when supplied with electricity, thereby driving the magnetically inductive member and the drive gear to deliver the fluid.

2. The compact fluid pump as claimed in claim 1, further comprising an inlet pipe and an outlet pipe connected to the housing and in communication with the interior space of the housing, the inlet pipe allowing input of the fluid into the interior space of the housing, and the outlet pipe allowing output of the fluid carried by the drive gear out of the housing.

3. The compact fluid pump as claimed in claim 1, wherein the magnetically inductive member is made of magnetic material and comprises a plurality of pole sections.

4. The compact fluid pump as claimed in claim 1, wherein the stator device comprises at least two coils.

5. The compact fluid pump as claimed in claim 4, wherein the stator device further comprises at least two iron cores respectively mounted inside an associated one of said at least two coils to increase alternating energizing intensity.

6. The compact fluid pump as claimed in claim 4, wherein the stator device further comprises at least one sensor mounted between said at least two coils for detecting a change in polarity during rotation of the magnetically inductive member.

7. The compact fluid pump as claimed in claim 1, wherein the stator device is concentric with the drive gear and the magnetically inductive member.

8. The compact fluid pump as claimed in claim 1, wherein the housing comprises a lid mounted thereto for defining the sealed interior space.

9. The compact fluid pump as claimed in claim 8, wherein each of the housing and the lid comprises a shaft seat, the drive gear comprising a shaft that is rotatably coupled to the shaft seat of the housing and the shaft seat of the lid.

10. The compact fluid pump as claimed in claim 8, wherein the lid further comprises a recessed portion for receiving the stator device.

11. The compact fluid pump as claimed in claim 8, wherein the stator device further comprises a circuit board and wherein the lid further comprises a recessed portion for receiving the circuit board.

12. The compact fluid pump as claimed in claim 9, wherein the drive gear comprises a recessed portion surrounding the shaft of the drive gear for securely receiving the magnetically inductive member.

13. The compact fluid pump as claimed in claim 1, wherein the magnetically conductive member further comprises an insulating layer to avoid rusting.

14. The compact fluid pump as claimed in claim 1, further comprising at least one driven gear rotatably mounted in the interior space of the housing and meshed with the drive gear.
